(19) United States
(12) Patent Application Publication
(10) Pub. No.: US 2026/0159704 A1
(43) Pub. Date: Jun. 11, 2026

(54) HARD COAT FILM

(71) Applicant: DEXERIALS AMERICA CORPORATION, Suwanee, GA (US)

(72) Inventors: Deborah NASH-MAKITA, Suwanee, GA (US); Ryosuke ENDO, Suwanee, GA (US)

(73) Assignee: DEXERIALS AMERICA CORPORATION, Suwanee, GA (US)

(21) Appl. No.: 18/862,408

(22) PCT Filed: Nov. 30, 2022
(86) PCT No.: PCT/US2022/051375

§ 371 Date: Nov. 1, 2024

Related U.S. Application Data
(60) Provisional application No. 63/337,894, filed on May 3, 2022.

(51) Int. Cl. C09D 5/16; C08J 7/04; C08J 7/046; C09D 4/00; C09D 7/40; C09D 7/61; C09D 135/02; C09D 171/00

(52) U.S. Cl. CPC C09D 5/1693; C08J 7/042; C08J 7/0427; C08J 7/046; C09D 4/00; C09D 5/1662; C09D 7/61; C09D 7/67; C09D 135/02; C09D 171/00; C08J 2335/02; C08J 2371/00

(57) ABSTRACT

A hard coat film 10 includes a base material 11, and a hard coating layer 12 composed of a cured product of a resin composition containing a resin (A) and a resin (B), the hard coating layer 12 being laminated on the base material 11. The resin (A) is a polyfunctional (meth)acrylic monomer having a weighted average of functionality of more than or equal to 4. The resin (B) is an aliphatic urethane acrylate. A glass transition temperature Tg of the hard coating layer 12 is more than or equal to 50° C. and less than or equal to 100° C. In a case of measuring a loss tangent tan δ of the hard coating layer 12 by dynamic viscoelastic measurement of applying a 1-Hz frequency dynamic load, the loss tangent tan δ at the glass transition temperature Tg is more than or equal to 0.07 and less than or equal to 0.15.

### TECHNICAL FIELD

The present disclosure relates to a hard coat film.

### BACKGROUND ART

Display devices such as liquid crystal displays (LCDs), plasma displays (PDPs), or organic EL displays (OLEDs) are widely used for smartphones, mobile telephones, mobile personal computers, car navigation devices, and the like. In general, the outermost surface of the screen of a display device is provided with a protective film for preventing the screen from getting scratched. The protective film includes a base material and a hard coating layer laminated on the base material. Conventional hard coating layers are made of materials each having a high crosslinking density.

Presently, foldable flexible display devices having flexible screens are being developed. It is required that such flexible display devices be repeatedly foldable in one or more directions, multiple times, such as several hundred thousand times. Thus, the protective film that covers the screen of a flexible display device is also required to have flexibility so as to withstand the above-described multiple and repeated folds.

However, while materials having a high crosslinking density used for conventional hard coating layers have hardness, they have a high shrinkage factor, resulting in a lack of flexibility. Therefore, when a flexible display device is covered by a protective film having a conventional hard coating layer, and that flexible display device is folded repeatedly multiple times, such as several hundred thousand times, the hard coating layer and the protective film are easy to separate from the screen. In addition, when the material of the hard coating layer has a high crosslinking density, the hard coating layer is fragile, or the hard coating layer is easily cracked even if the hard coating layer itself is thin.

Thus, Patent Literature 1, for example, discloses a hard coating layer having a thickness of 5 μm that can be bent around a mandrel having a diameter of 2 mm without cracking, as a flexible hard coating layer.

### CITATION LIST

### Patent Literature

Patent Literature 1: US 2009/0004478 A1

### SUMMARY OF INVENTION

### Technical Problem

However, Patent Literature 1 above fails to disclose repeatedly folding the hard coating layer multiple times, such as several hundred thousand times, the material of the hard coating layer, and properties of the hard coating layer required for such repeated folding, and the like.

In addition, if the hard coating layer is made of a soft material for enabling multiple folds, scratch resistance of the hard coating layer is reduced, and the hard coating layer is easily scratched accordingly. Therefore, the hard coating layer to be used as the protective film for the flexible display device is required to have not only performance capable of withstanding the above-described multiple and repeated folds, but also scratch resistance for preventing scratches.

The present invention was therefore made in view of the above problems, and has an object to provide a hard coat film having both performance capable of withstanding multiple and repeated folds and scratch resistance.

### Solution to Problem

In order to solve the above problems, according to an aspect of the present invention, provided is a hard coat film including:
a base material; and
a hard coating layer including a cured product of a resin composition containing a resin (A) and a resin (B), the hard coating layer being laminated on the base material, in which
the resin (A) is a polyfunctional (meth)acrylic monomer having a weighted average of functionality of more than or equal to 4,
the resin (B) is an aliphatic urethane acrylate,
a glass transition temperature Tg of the hard coating layer is more than or equal to 50° C. and less than or equal to 100° C., and
a loss tangent tan δ at the glass transition temperature Tg is more than or equal to 0.07 and less than or equal to 0.15,
wherein the loss tan δ of the hard coating layer is measured by dynamic viscoelastic measurement applying a 1-Hz frequency dynamic load.

The resin composition may further contain metal oxide nanoparticles having an average particle size of less than or equal to 100 nm.

In certain embodiments, the content of the metal oxide nanoparticles contained in the resin composition may be more than or equal to 2% by mass and less than or equal to 5% by mass of the total solid content of the resin composition of the hard coating layer.

A metal oxide in the metal oxide nanoparticles may be either or both of silica and alumina.

The metal oxide nanoparticles may have a Mohs hardness of more than 6.

A water contact angle of the surface of the hard coating layer after abrasion may be more than 100°, wherein abrasion is performed using an abrasion tester through the use of steel wool #0000, abrading a surface of the hard coating layer with the steel wool under conditions of a load of 1000 g, a speed of 50 mm/sec, a reciprocating distance of 40 mm, and 2500 reciprocations.

In certain embodiments, the water contact angle of the surface of the hard coating layer before abrasion may be more than 110°.

In certain embodiments, the decrease in the water contact angle after abrasion with respect to the water contact angle of the surface of the hard coating layer before abrasion may be less than 13%.

In certain embodiments, the content of resin (A) contained in the resin composition may be more than two times and less than nine times the content of resin (B).

In certain embodiments, the content of the resin (A) contained in the resin composition may be more than or equal to 20% by mass and less than or equal to 40% by mass, and the content of the resin (B) contained in the resin composition may be more than or equal to 2% by mass and less than or equal to 15% by mass.

The hard coat film may be configured to be foldable by either inbending or outbending at least one hundred thousand times without causing any cracking, interlayer separation, or loss of an optical property.

The base material may be a thermoplastic base material having a thickness of more than or equal to 10 μm and less than or equal to 200 μm.

The resin composition may contain a fluorine compound, and the fluorine compound may be segregated to a first region located on a side of a surface of the hard coating layer.

In addition, the fluorine compound as segregated may provide an antifouling effect.

In certain embodiments, the fluorine compound may be segregated to the surface of the hard coating layer.

In certain embodiments the hard coat film may be configured to be foldable by either inbending or outbending at least one hundred thousand times without any loss of an optical property, wherein the optical property is one or more selected from the group consisting of variations in total transmittance (%), transmission haze, gloss, and chromaticity b*(intensity of color tone from blue to yellow).

In certain embodiments, there may be a second region located on a side of the base material of the hard coating layer, in which the fluorine compound is not segregated.

### Advantageous Effects of Invention

According to an embodiment of the present invention, a hard coat film having both performance capable of withstanding multiple and repeated folds and scratch resistance can be provided.

### BRIEF DESCRIPTION OF DRAWINGS

FIG. 1 is a cross-sectional view showing a hard coat film according to an embodiment of the present invention.

FIG. 2 is a cross-sectional view showing a hard coat film according to another embodiment of the present invention.

FIG. 3 is a cross-sectional view showing a hard coat film according to another embodiment of the present invention.

FIG. 4 is a schematic drawing showing a hard coat film manufacturing apparatus according to the embodiment.

### DESCRIPTION OF EMBODIMENTS

Hereinafter, an embodiment of the present invention will be described in detail with reference to the accompanying drawings. Dimensions, materials, specific numerical values, and the like which will be described in such an embodiment are merely illustrative for facilitating understanding of the invention, and the present invention is not limited thereto unless otherwise specified. Note that in the present specification and drawings, elements having substantially the same function and configuration have the same reference character allotted, and repeated description thereof will be omitted. In addition, illustration of elements not directly pertinent to the present invention may be omitted.

Note that in the respective drawings which will be referred to in the following description, the sizes of some components may be exaggerated for ease of description. Therefore, the relative sizes of components depicted in the respective drawings do not necessarily convey the actual precise proportional relationship between the components.

### [1. Overall Configuration of Hard Coat Film]

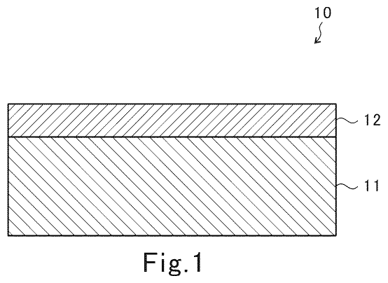

First, an overall configuration of a hard coat film 10 according to an embodiment of the present invention will be described with reference to FIG. 1. FIG. 1 is a cross-sectional view showing the hard coat film 10 according to the present embodiment.

The hard coat film 10 according to the present embodiment is provided on the outermost surface of a flexible display device as a protective film for preventing scratches, for example. As shown in FIG. 1, the hard coat film 10 according to the present embodiment includes a base material 11, and a hard coating layer 12. The hard coating layer 12 is laminated on the base material 11. Each layer will be described below.

### [Base Material 11]

The base material 11 is made from a transparent material that can transmit light in a visual light range having a wavelength of from 350 to 830 nm, for example.

The base material 11 may be an inorganic material such as a glass film, or an organic material such as a plastic film, for example.

The material of the plastic film may be one or more selected from the group consisting of polyester resins, acetate resins, polyethersulfone resins, polycarbonate resins, polyamide resins, polyimide resins, polyolefin resins, poly(meth)acrylate resins, polyvinyl chloride resins, polyvinylidene chloride resins, polystyrene resins, polyvinyl alcohol resins, polyarylate resins, and polyphenylenesulfide resins, for example, and preferably is one or more of polyester resins, acetate resins, polycarbonate resins, polyimide resins, and polyolefin resins.

In terms of handling ability, flexibility, cost, and properties, the thickness of the base material 11 is preferably more than or equal to 10 μm and less than or equal to 200 μm, for example, more preferably is more than or equal to 20 μm and less than or equal to 100 μm, and still more preferably is more than or equal to 40 μm and less than or equal to 60 μm.

When the thickness of the base material 11 is more than or equal to 10 μm, at least one of the following advantages is achieved. Since the rigidity of the base material 11 itself can be ensured, the hard coat film 10 is less likely to get crinkled even when stress is applied to the hard coat film 10. In addition, even if the hard coating layer 12 is formed continuously on the base material 11, manufacturing problems involving the hard coat film 10 can be reduced since the hard coat film 10 is less likely to get crinkled. In addition, a reduction of curling of the hard coat film 10 eliminates the need to laminate another coating layer on the rear surface of the base material 11. Note that the rear surface of the base material 11 refers to a surface opposite the surface on which the hard coating layer 12 is laminated.

When using a roll when manufacturing the hard coat film 10, the thickness of the base material 11 is preferably less than or equal to 200 μm. When the thickness of the base material 11 is less than or equal to 200 μm, the hard coat film 10 during manufacturing and the hard coat film 10 after manufacturing are easy to wind into a roll shape, resulting in efficient manufacturing of the hard coat film 10. In addition, the base material 11 desirably is a thermoplastic base material.

The base material 11 may be subjected to a surface treatment in advance for a purpose such as improving adhesion. The surface treatment may include one or more treatments such as a corona treatment, a plasma treatment, an ultraviolet treatment, an excimer treatment, and a primer treatment, for example. To improve adhesion, a surface treatment including the use of a silane coupling agent is particularly desirable. In addition, before forming the hard coating layer 12 on the base material 11, it is also preferable to dedust and clean the surface of the base material 11 with a web cleaner or the like, as necessary.

### [Hard Coating Layer 12]

The hard coating layer 12 is provided on the base material 11. The hard coating layer 12 may be a cured product of a resin composition, for example. In certain embodiments, the resin composition contains a resin (A), a resin (B), an active energy ray polymerization initiator, and a solvent.

The resin (A) and the resin (B) may be energy ray curable resins such as an ultraviolet curable resin, an electron beam curable resin, or an infrared curable resin. Note that ultraviolet curable resins are preferably used as resin (A) and resin (B). This is because the need for posttreatment after curing is eliminated. Curing in a nitrogen atmosphere is desirable for an appropriate curing treatment.

The resin (A) may be a polyfunctional (meth)acrylic monomer having a weighted average of functionality of more than or equal to 4. The number of the weighted average of functionality of the resin (A) preferably exceeds 4.2 and is less than 5.1. In this embodiment, the resin (A) contains a bifunctional acrylic monomer and a hexafunctional acrylic monomer, for example. Examples of the bifunctional acrylic monomer can include the product “SR833S” (difunctional tricyclodecanedimethanol diacrylate) and the product “SR306” (tripropylene glycol diacrylate), both available from SARTOMER. Examples of the hexafunctional acrylic monomer can include the product “DPHA” (dipentaerythritol hexaacrylate) available from DAICEL-ALLNEX LTD., and the like. Here, instead of or with the bifunctional acrylic monomer, at least one of a trifunctional acrylic monomer, a tetrafunctional acrylic monomer, or a pentafunctional acrylic monomer may be used. Examples of the trifunctional monomer can include “SR351” (trimethylolpropane triacrylate) or “SR454” (ethoxylated trimethylolpropane triacrylate), both available from SARTOMER. Examples of the tetrafunctional monomer can include “SR295” (pentaerythritol tetraacrylate), “SR355” (di-trimethylolpropane tetraacrylate), or “SR494” (ethoxylated pentaerythritol tetraacrylate), all available from SARTOMER. Example of the pentafunctional monomer can include “SR399” (dipentaerythritol pentaacrylate), available from SARTOMER.

In certain embodiments, the resin (B) is an aliphatic urethane acrylate. The resin (B) is, for example, a trifunctional aliphatic urethane acrylate, a trifunctional aliphatic polyester urethane acrylate, or the like. Commercially available specific examples of the resin (B) can include the product “CN989” (trifunctional aliphatic urethane acrylate) and the product “CN929” (trifunctional aliphatic polyester urethane acrylate), both available from SARTOMER, and the like.

By making the hard coating layer 12 a cured product of a resin composition containing the resin (A) which is a polyfunctional (meth)acrylic monomer having a weighted average of functionality of more than or equal to 4 described above and the resin (B) which is an aliphatic urethane acrylate, the glass transition temperature Tg of the hard coating layer 12 can be more than or equal to 50° C. and less than or equal to 100° C. In addition, by making the hard coating layer 12 similarly, the loss tangent tan δ of the hard coating layer 12 at the glass transition temperature Tg can be more than or equal to 0.07 and less than or equal to 0.15. The loss tangent tan δ of the hard coating layer 12 at the above-described glass transition temperature Tg is the value calculated via dynamic viscoelastic measurement applying a 1-Hz frequency dynamic load. In addition, the loss tangent tan δ is the ratio between the storage modulus (E′) and the loss modulus (E″) (tan δ=E″/E′). The storage modulus (E′) is an internal energy increased component when a strain occurs in a target. The storage modulus (E′) indicates an elastic property of the target. The loss modulus (E″) is a lost energy component when a strain occurs in the target. Lost energy is energy diffused as heat to the outside of the target. The loss modulus (E″) indicates a viscosity property of the target.

When the glass transition temperature Tg is less than 50° C., the hard coating layer 12 will be softened in an in-vehicle or similar high-temperature environment, and the scratch resistance of the hard coating layer 12 will be significantly reduced. On the other hand, when the glass transition temperature Tg exceeds 100° C., the flexibility of the hard coating layer 12 cannot be ensured, which will make it difficult to repeatedly fold the hard coating layer 12 multiple times.

Thus, the glass transition temperature Tg of the hard coating layer 12 preferably is set at more than or equal to 50° C. and less than or equal to 100° C. Accordingly, the scratch resistance of the hard coating layer 12 can be improved even in an in-vehicle or similar high-temperature environment, and the hard coating layer 12 can also be repeatedly folded multiple times more than or equal to one hundred thousand times.

When the loss tangent tan δ of the hard coating layer 12 at the glass transition temperature Tg is less than 0.07, the hardness of the hard coating layer 12 will become excessively high and will reduce the flexibility of the hard coating layer 12. On the other hand, when the loss tangent tan δ of the hard coating layer 12 at the glass transition temperature Tg is more than 0.15, the hardness of the hard coating layer 12 will become excessively low and will reduce the scratch resistance of the hard coating layer 12.

Thus, the loss tangent tan δ of the hard coating layer 12 at the glass transition temperature Tg is preferably set at more than or equal to 0.07 and less than or equal to 0.15. Accordingly, the scratch resistance of the hard coating layer 12 can be improved, and the hard coating layer 12 can also be repeatedly folded multiple times more than or equal to one hundred thousand times.

The content (% by mass) of the resin (A) contained in the resin composition is preferably more than two times and less than nine times, is more preferably more than or equal to four times and less than nine times, and is still more preferably more than or equal to four times and less than or equal to five times the content (% by mass) of the resin (B). The content of the resin (A) contained in the resin composition is preferably more than or equal to 20% by mass and less than or equal to 40% by mass, and is more preferably more than or equal to 26% by mass and less than or equal to 33% by mass. The content of the resin (B) contained in the resin composition is preferably more than or equal to 2% by mass and less than or equal to 15% by mass, and is more preferably more than or equal to 4.5% by mass and less than or equal to 11.5% by mass.

In certain embodiments, the active energy ray polymerization initiator is a Norrish Type I photoinitiator or a Norrish Type II photoinitiator. Commercially available specific examples of the active energy ray polymerization initiator can include the product “OMNIRAD 184 (IRGACURE 184)” (1-hydroxycyclohexyl-phenyl ketone), “OMNIRAD 500 (IRGACURE 500)” (a mixture of benzophenone and 1-hydroxycyclohexyl-phenyl ketone), and “OMNIRAD TPO” (2,4,6-trimethylbenzoyl-diphenyl phosphine oxide), all available from IGM RESINS (former BASF), and the like.

The solvent is not particularly limited as long as the coating property of the resin composition is satisfied, and the solvent is preferably selected considering safety. In certain embodiments, the solvent contains one or more selected from the group consisting of, for example, alcohol solvents such as ethanol, n-propyl alcohol, isopropyl alcohol, n-butyl alcohol, isobutyl alcohol, and diacetone alcohol, ketone solvents such as acetone, methyl ethyl ketone (hereinafter, MEK), methyl isobutyl ketone, and cyclohexanone, ester solvents such as methyl acetate, butyl acetate, propylene glycol monomethylether acetate (hereinafter, PGMEA), ether solvents such as propylene glycol monomethylether (hereinafter, PGME), diethyl ether, and diisopropyl ether, and the like. The solvent preferably contains any one of MEK, PGME, and PGMEA. It is particularly preferable to use either or both of PGME and PGMEA, and the coating property of the resin composition may be improved accordingly.

The thickness of the hard coating layer 12 is preferably more than or equal to 3 μm, and is more preferably more than or equal to 5 μm, for example. When the thickness of the hard coating layer 12 is more than or equal to 3 μm, sufficient hardness is obtained, so that the hard coating layer 12 is less likely to get scratched in a manufacturing process. In addition, the thickness of the hard coating layer 12 preferably is less than or equal to 15 μm, and more preferably is less than or equal to 10 μm. When the thickness of the hard coating layer 12 is less than or equal to 15 μm, micro-cracks that would occur when the hard coat film 10 is bent during manufacturing are less likely to be produced in the hard coating layer 12, resulting in favorable productivity of the hard coat film 10.

Metal oxide nanoparticles may be contained in the above-described resin composition of the hard coating layer 12 in a dispersed manner. When the resin composition contains the metal oxide nanoparticles, the hardness of the hard coating layer 12 can be increased.

The average particle size of the metal oxide nanoparticles preferably is less than or equal to 100 nm, and more preferably is less than or equal to 50 nm, for example. Note that in the present embodiment, the average particle size refers to a value measured by a BET method.

When the average particle size of the metal oxide nanoparticles is more than 100 nm, light transmittance of the hard coating layer 12 in the visual light range may be reduced. Therefore, by setting the average particle size of the metal oxide nanoparticles at less than or equal to 100 nm, the light transmittance of the hard coating layer 12 in the visual light range can be maintained. By setting the average particle size of the metal oxide nanoparticles at less than or equal to 50 nm, these advantages can further be exerted. When the base material 11 is an opaque base material, the average particle size of the metal oxide nanoparticles may be more than 100 nm since the hard coating layer 12 may not have high light transmittance.

The content of the metal oxide nanoparticles (excluding monomer) in the resin composition is preferably more than or equal to 2% by mass and less than or equal to 5% by mass of the total solid content of the resin composition of the hard coating layer 12. When the content of the metal oxide nanoparticles is more than 5% by mass, the hard coating layer 12 tends to be brittle. Therefore, by setting the content of the metal oxide nanoparticles according to the present embodiment to fall within the above-described range, the flexibility of the hard coating layer 12 can be maintained. The solid content of the resin composition refers to the total content excluding the solvent, and a liquid monomer content is also included in the solid content.

The metal oxide constituting the metal oxide nanoparticles in certain embodiments is either or both of SiO₂ (silica) and Al₂O₃ (alumina). This can prevent the light transmittance of the hard coating layer 12 in the visual light range from being reduced.

The metal oxide nanoparticles preferably have a Mohs hardness of more than 6. This can increase the hardness of the hard coating layer 12 without reducing the flexibility of the hard coating layer 12.

### [Antifouling Layer 13]

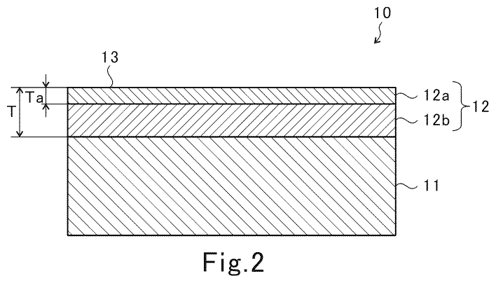

In certain embodiments of the present invention, an antifouling layer 13 may be provided as part of the hard coating layer 12. FIG. 2 is a cross-sectional view showing the hard coat film 10 according to the certain embodiment. As shown in FIG. 2, the fluorine compound contained in the hard coating layer 12 is segregated to a first region 12a located on a side of a surface of the hard coating layer 12 to form an antifouling layer 13. The fluorine compound is not segregated in a second region 12b located on a side of the base material 11 of the hard coating layer 12. In other words, the amount of fluorine compounds in the second region 12b is less than the amount of fluorine compounds in the first region 12a. The fluorine compound may be included in the second region 12b. The fluorine compound may be dispersed (discrete) in the second region 12b. The first region 12a has a thickness Ta of up to, for example, 10% of the total thickness T of the hard coating layer 12. The second region 12b is a region other than the first region 12a in hard coating layer 12. As used herein, the term “segregation” means that the distribution of a fluorine compound in the resin composition becomes greater on the side of the surface of the hard coating layer 12 than on the side of the base material 11 during the curing of the resin composition. The antifouling layer 13 prevents the hard coating layer 12 from being contaminated. The antifouling layer 13 may or may not form a precise layer depending on a segregated state of the fluorine compound.

The antifouling layer 13 contains a fluorine compound. The fluorine compound preferably has a (meth)acryl group. In addition, the fluorine compound preferably is a perfluoropolyether derivative rather than a fluoroalkyl derivative in terms of environmental regulations and the like. The fluorine compound may be a hybrid material of an organic material and an inorganic material. Examples of the hybrid material can include fluorine-containing silsesquioxane. In the present embodiment, the antifouling property and chemical resistance of the hard coat film can be improved because the antifouling layer 13 contains the fluorine compound. The chemical resistance is resistance to acids, bases, solvents, and oils, for example.

Examples of the fluorine compound contained in the antifouling layer 13 can include the product “KY-1203” available from SHIN-ETSU CHEMICAL CO., LTD., the product “OPTOOL DAC-HP” available from DAIKIN INDUSTRIES, LTD., the product “FLUOROLINK AD1700” available from SOLVAY SPECIALTY POLYMERS, the product “CN4000” available from SARTOMER, and the like.

### [2. Properties of Hard Coating Layer 12]

Next, properties of the hard coating layer 12 according to the present embodiment will be described. The hard coating layer 12 according to the present embodiment has at least one of properties (I) to (IV) below, for example.

### (I) Glass Transition Temperature Tg and Loss Tangent Tan δ

The glass transition temperature Tg of the hard coating layer 12 is more than or equal to 50° C. and less than or equal to 100° C., and preferably is more than or equal to 60° C. and less than or equal to 90° C. The loss tangent tan δ is more than or equal to 0.07 and less than or equal to 0.15, and preferably is more than or equal to 0.09 and less than or equal to 0.13.

Accordingly, the scratch resistance and abrasion resistance of the hard coating layer 12 can be improved even in an in-vehicle or similar high-temperature environment, and the hard coating layer 12 can be repeatedly folded multiple times more than or equal to one hundred thousand times.

The glass transition temperature Tg and the loss tangent tan δ can be measured using a Dynamic Mechanical Analyzer DMA7100 available from HITACHI HIGH-TECH SCIENCE CORPORATION, for example.

Measurement conditions for dynamic viscoelastic measurement when calculating the glass transition temperature Tg and the loss tangent tan δ are as follows.
Frequency-induced sine wave vibration: 1 Hz
Sample size: 20-mm long×4.4-mm wide×0.10-mm thick
Test method: raising the temperature from 20° C. to 200° C. at a rate of 10° C./min

### (II) the Number of Folds

The hard coat film 10 is configured to be foldable by either inbending or outbending at least one hundred thousand times without causing any cracking, interlayer separation, or loss of an optical property. Herein, the optical property referred to includes variations in total transmittance (%), transmission haze, gloss, or chromaticity b*(intensity of color tone from blue to yellow), for example. The above-described configuration can avoid the separation of the hard coat film 10 from the flexible display device even when the flexible display device covered by the hard coat film 10 is folded repeatedly multiple times of several hundred thousand times.

The number of folds (the number of bends) can be measured using a folding test device (mandrel diameter: 3 mm, bending radius: 1.5 mm) available from YUASA SYSTEM CO., LTD., for example.

### (III) Water Contact Angle (WCA)

The water contact angle is the angle formed by the surface of a water droplet and the surface of the hard coating layer 12 when the water droplet is brought into contact with the surface of the hard coating layer 12. The water contact angle is measured before and after executing an abrasion test.

The abrasion test is a test of, using an abrasion tester through use of steel wool #0000, abrading the surface of the hard coating layer 12 with the steel wool under conditions of a load of 1000 g, a speed of 50 mm/sec, a reciprocating distance of 40 mm, and 2500 reciprocations.

The water contact angle θ1 of the surface of the hard coating layer 12 before execution of the abrasion test (before abrasion) desirably is more than 110° and less than 120°. The water contact angle θ2 of the surface of the hard coating layer 12 after execution of the abrasion test (after abrasion) desirably is more than 100° and less than the water contact angle θ1.

The decrease in the water contact angle of the surface of the hard coating layer 12 before and after abrasion is preferably less than 13%, and more preferably is less than or equal to 7.6%. Having a low decrease in the water contact angle means that the hard coating layer 12 is hardly shaved even if hard coating layer 12 is subjected to the abrasion test, that is, the abrasion resistance is excellent. Herein, the decrease in the water contact angle can be obtained by of the formula: (the water contact angle before the abrasion test−the water contact angle after the abrasion test)/the water contact angle before the abrasion test×100.

The water contact angle can be measured using an automatic contact angle meter DM-501Hi available from KYOWA INTERFACE SCIENCE CO., LTD., for example.

### (IV) Visible Scratches

After executing the above-described abrasion test on the hard coating layer 12 according to the present embodiment, visible scratches were not recognized in the hard coating layer 12. In other words, it is appreciated that in the hard coat film 10 according to the present embodiment, the hard coating layer 12 is less likely to get scratched and has excellent scratch resistance.

### [3. Apparatus for Manufacturing Hard Coat Film 10]

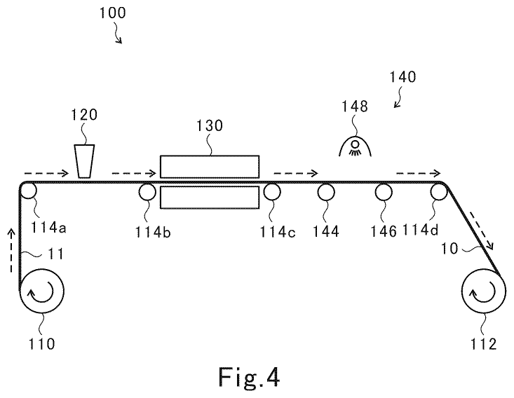

FIG. 4 is a schematic drawing showing a film manufacturing apparatus 100 according to the present embodiment. As shown in FIG. 4, the film manufacturing apparatus 100 includes a delivery roll 110, a wind-up roll 112, guide rolls 114a to 114d, a coating device 120, a drying device 130, and a curing device 140. In FIG. 4, solid arrows indicate the direction in which the rolls rotate. In FIG. 4, broken arrows indicate the direction in which the base material 11 is conveyed.

The base material 11 in strip form is wound around the delivery roll 110 into a roll shape. The delivery roll 110 is arranged such that the base material 11 can be delivered continuously by means of the guide roll 114a and the like.

The wind-up roll 112 is arranged such that the hard coat film 10 in strip form manufactured by the film manufacturing apparatus 100 can be wound up.

The guide rolls 114a to 114d are arranged on a conveyance path in the film manufacturing apparatus 100 such that the base material 11 in strip form and the hard coat film 10 in strip form can be conveyed. The material of the guide rolls 114a to 114b is selected as appropriate in accordance with a desired roll property. The material of the guide rolls 114a to 114b is, for example, metal such as stainless steel, rubber, silicon resin, or the like.

The coating device 120 is provided between the guide roll 114a and the guide roll 114b. The coating device 120 laminates a resin composition on (for example, applies the resin composition to) the base material 11. The coating device 120 is a gravure coater, a wire bar coater, a die coater, or the like, for example.

The drying device 130 is provided between the guide roll 114b and the guide roll 114c. The drying device 130 heats the base material 11 to which the resin composition has been applied, thereby drying the resin composition. The drying device 130 vaporizes the solvent contained in the resin composition. This allows the solvent to be removed from the resin composition.

The curing device 140 is provided between the guide roll 114c and the guide roll 114d. The curing device 140 includes guide rolls 144, 146 and a light source 148 that irradiates the resin composition with an energy ray. Examples of the energy ray include an electron beam, ultraviolet rays, visible light rays, gamma rays, and the like. The guide rolls 144 and 146 come into contact with the rear surface of the base material 11 to which the resin composition has been applied, thereby delivering the base material 11 toward the guide roll 114d.

Next, a method of manufacturing the hard coat film 10 using the film manufacturing apparatus 100 will be described. First, the base material 11 is delivered from the delivery roll 110. The delivered base material 11 passes under the coating device 120 by way of the guide roll 114a. The coating device 120 applies the resin composition to the base material 11 passing under the coating device 120. The base material 11 to which the resin composition has been applied is conveyed to the drying device 130 by way of the guide roll 114b. The drying device 130 dries the resin composition applied to the base material 11.

The base material 11 on which the dried resin composition is laminated is conveyed to the curing device 140 by way of the guide roll 114c, and the resin composition is irradiated with an energy ray from the light source 148. The resin composition is thereby cured, and the hard coat film 10 with the hard coating layer 12 laminated on the base material 11 is manufactured.

The hard coat film 10 thus manufactured is wound up around the wind-up roll 112 by way of the guide rolls 146 and 114d.

Note that the resin composition preferably contains a fluorine compound. Accordingly, when the solvent is evaporated by the drying device 130, the fluorine compound is caused to float up over the resin composition as the solvent is dried and rises, so that the antifouling layer 13 can be formed.

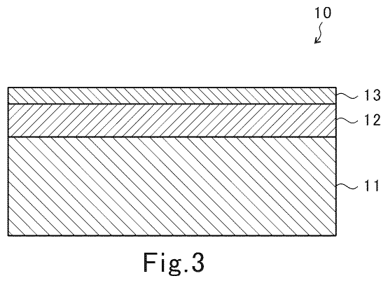

Note that the antifouling layer 13 may be obtained by separately laminating a layer containing a fluorine compound after forming the hard coating layer 12. FIG. 3 is a cross-sectional view showing the hard coat film 10 according to the certain embodiment. As shown in FIG. 3, the antifouling layer 13 may be a separate layer from the hard coating layer 12. In this case, the antifouling layer 13 is formed on the hard coating layer 12. In the case of forming the antifouling layer 13 in a separate step, a method such as coating, vapor deposition, or sputtering can be used. In the case of using the coating method, an apparatus similar to the film manufacturing apparatus 100 can be used. Thus, the antifouling layer 13 may be part of the hard coating layer 12 or may be a different layer from the hard coating layer 12.

### EXAMPLES

Hereinafter, examples of the present invention and comparative examples will be specifically described. the examples which will be described below are merely illustrative, and the hard coat film according to the present invention is not limited to the following examples.

Examples 1 to 13 and Comparative Examples 1 to 8 were produced as the hard coating layer and the antifouling layer. When producing the hard coating layer and the antifouling layer, resin compositions each containing the resin (A), the resin (B), the active energy ray polymerization initiator, the solvent, and the fluorine compound were prepared. Formulations of resin compositions of Examples 1 to 5 are shown in Table 1 below. Formulations of resin compositions of Examples 6 to 10 are shown in Table 2 below. Formulations of resin compositions of Examples 11 to 13 are shown in Table 3 below. Formulations of resin compositions of Comparative Examples 1 to 5 are shown in Table 4 below. Formulations of resin compositions of Comparative Examples 6 to 8 are shown in Table 5 below. Note that the unit of blending ratio in Tables 1 to 5 is % by mass.

The glass transition temperature Tg, the loss tangent tan δ (tan Delta, peak) at the glass transition temperature Tg, the number of folds, water contact angles (WCA) before and after the abrasion test, and visible scratches of hard coat films according to Examples 1 to 13 and Comparative Examples 1 to 8 were measured.

the glass transition temperature Tg and the loss tangent tan δ at the glass transition temperature Tg were measured using a Dynamic Mechanical Analyzer DMA7100 available from HITACHI HIGH-TECH SCIENCE CORPORATION. Measurement conditions for dynamic viscoelastic measurement when calculating the loss tangent tan δ were similar to those in the above-described embodiment.

The number of folds were measured using the folding test device (mandrel diameter: 3 mm, bending radius: 1.5 mm) available from YUASA SYSTEM CO., LTD. In Tables 1 to 5, the evaluation of a folding test result is indicated on a scale of 1 to 3. In Tables 1 to 5, a rating of “3” indicates an excellent rating at which there was no change even after two hundred thousand (200K) folds. In Tables 1 to 5, a rating of “2” indicates an acceptable rating at which there was no change even after one hundred thousand (100K) folds. In Tables 1 to 5, a rating of “1” indicates a poor rating at which a change occurred before 100K folds.

The water contact angles were measured with 2.0-μL pure water dropped on the surface of the hard coat film according to each of experimental examples before and after abrasion with an abrasion tester through use of steel wool. Abrasion was conducted on the surface of the hard coat film under conditions of a load of 1000 g, a speed of 50 mm/sec, a reciprocating distance of 40 mm, and 2500 reciprocations. In addition, an average value of water contact angles measured ten times at the center of an abraded portion was calculated. Water contact angles shown in Tables 1 to 5 below are average values. The water contact angles were measured using an automatic contact angle meter DM-501Hi available from KYOWA INTERFACE SCIENCE CO., LTD.

After conducting the above-described abrasion test, whether scratches had occurred in the surface of the hard coat film according to each of the experimental examples was visually checked.

TABLE 1

| Formulation | | Example 1 | Example 2 | Example 3 | Example 4 | Example 5 |
|---|---|---|---|---|---|---|
| monomer | SR833S | 5.64 | 7.52 | 7.52 | 9.4 | 5.64 |
| (A) | DPHA | 22.56 | 22.56 | 18.8 | 20.68 | 24.44 |
| oligomer | CN989 | 9.4 | 7.52 | 11.28 | 7.52 | 7.52 |
| (B) | CN929 | — | — | — | — | — |
| photoinitiator | Omnirad 184 | — | — | — | — | — |
| | Omnirad 500 | 5.64 | 5.64 | 5.64 | 5.64 | 5.64 |
| | Omnirad TPO | 1.41 | 1.41 | 1.41 | 1.41 | 1.41 |
| solvent | PGME | 46.984 | 46.984 | 46.984 | 46.984 | 46.984 |
| nanoparticle | AL2260 | 7.52 | 7.52 | 7.52 | 7.52 | 7.52 |
| fluorinated additive | KY-1203 | 0.846 | 0.846 | 0.846 | 0.846 | 0.846 |
| TOTAL | | 100.00 | 100.00 | 100.00 | 100.00 | 100.00 |
| A/B | | 3.56 | 4.70 | 2.80 | 4.70 | 4.70 |
| Weighted average of functionality | | 4.70 | 4.55 | 4.38 | 4.34 | 4.77 |
| Properties | tan Delta, peak | 0.1046 | 0.1126 | 0.1246 | 0.1274 | 0.1017 |
| | Tg | 60.4 | 54.4 | 68.5 | 68.5 | 76.8 |
| | # Folds Passing | 200K | 200K | 200K | 200K | 200K |
| | (3 mm | | | | | |
| | outbending) | | | | | |
| | Folding | 3 | 3 | 3 | 3 | 3 |
| | Performance | | | | | |
| | Rating * | | | | | |
| | WCA before | 114.7 | 115.2 | 113.4 | 113.4 | 113.4 |
| | Abrasion | | | | | |
| | WCA after | 106 | 100.8 | 105.1 | 106.7 | 106.5 |
| | abrasion | | | | | |
| | WCA Falling Rate | 7.6 | 12.5 | 7.3 | 5.9 | 6.1 |
| | [%] | | | | | |
| | Visible Scratches | no | no | no | no | no |

* Folding Performance Rating:
3 = Exellent (no change after 200K folds)
2 = Acceptable (no change after 100K folds)
1 = Poor (changes occur before 100K folds

### Example 1

As shown in Table 1, the resin composition of Example 1 contained 5.64% by mass of “SR833S” available from SARTOMER and 22.56% by mass of “DPHA” available from DAICEL-ALLNEX LTD. as the resin (A), 9.4% by mass of “CN989” available from SARTOMER as the resin (B), 5.64% by mass of “OMNIRAD 500” available from IGM RESINS and 1.41% by mass of “OMNIRAD TPO” available from IGM RESINS as the active energy ray polymerization initiator, 46.984% by mass of “PGME” available from SIGMA-ALDRICH as the solvent, 7.52% by mass of “AL2260” available from NANOPHASE TECHNOLOGIES CORPORATION as the metal oxide nanoparticles, and 0.846% by mass of “KY-1203” available from SHIN-ETSU CHEMICAL CO., LTD. as the fluorine compound.

Herein, “AL2260” contains 30% by mass of alumina particles and 70% by mass of bifunctional monomer (TPGDA). Thus, the content of the bifunctional monomer is reflected in “Weighted average of functionality” and the content ratio between resin (A) and resin (B) (hereinafter referred to as “A/B”) of Examples 1 to 13 and Comparative Examples 1 to 8 is shown in Tables 1 to 5.

In Example 1, the weighted average of functionality of the resin (A) was 4.70, and A/B was 3.56.

In Example 1, the glass transition temperature Tg was 60.4° C. The loss tangent tan δ at the glass transition temperature Tg was 0.1046.

In the folding test of Example 1, there was no change even after 200K folds of the hard coat film (Rating “3”). In Example 1, the water contact angle before the abrasion test was 114.7°, and the water contact angle after the abrasion test was 106°. Visible scratches were not recognized.

### Example 2

As shown in Table 1, the resin composition of Example 2 contained 7.52% by mass of “SR833S” and 22.56% by mass of “DPHA” as resin (A), and 7.52% by mass of “CN989” as resin (B). The active energy ray polymerization initiator, the solvent, the metal oxide nanoparticles, and the fluorine compound contained in the resin composition of Example 2 were similar to those of Example 1.

In Example 2, the weighted average of functionality of the resin (A) was 4.55, and A/B was 4.70.

In Example 2, the glass transition temperature Tg was 54.4° C. The loss tangent tan δ at the glass transition temperature Tg was 0.1126.

In the folding test of Example 2, there was no change even after 200K folds of the hard coat film. In Example 2, the water contact angle before the abrasion test was 115.2°, and the water contact angle after the abrasion test was 100.8°. Visible scratches were not recognized.

### Example 3

As shown in Table 1, the resin composition of Example 3 contained 7.52% by mass of “SR833S” and 18.8% by mass of “DPHA” as resin (A), and 11.28% by mass of “CN989” as resin (B). The active energy ray polymerization initiator, the solvent, the metal oxide nanoparticles, and the fluorine compound contained in the resin composition of Example 3 were similar to those of Example 1.

In Example 3, the weighted average of functionality of the resin (A) was 4.38, and A/B was 2.80.

In Example 3, the glass transition temperature Tg was 68.5° C. The loss tangent tan δ at the glass transition temperature Tg was 0.1246.

In the folding test of Example 3, there was no change even after 200K folds of the hard coat film. In Example 3, the water contact angle before the abrasion test was 113.4°, and the water contact angle after the abrasion test was 105.1°. Visible scratches were not recognized.

### Example 4

As shown in Table 1, the resin composition of Example 4 contained 9.4% by mass of “SR833S” and 20.68% by mass of “DPHA” as resin (A), and 7.52% by mass of “CN989” as resin (B). The active energy ray polymerization initiator, the solvent, the metal oxide nanoparticles, and the fluorine compound contained in the resin composition of Example 4 were similar to those of Example 1.

In Example 4, the weighted average of functionality of the resin (A) was 4.34, and A/B was 4.70.

In Example 4, the glass transition temperature Tg was 68.5° C. The loss tangent tan δ at the glass transition temperature Tg was 0.1274.

In the folding test of Example 4, there was no change even after 200K folds of the hard coat film. In Example 4, the water contact angle before the abrasion test was 113.4°, and the water contact angle after the abrasion test was 106.7°. Visible scratches were not recognized.

### Example 5

As shown in Table 1, the resin composition of Example 5 contained 5.64% by mass of “SR833S” and 24.44% by mass of “DPHA” as resin (A), and 7.52% by mass of “CN989” as resin (B). The active energy ray polymerization initiator, the solvent, the metal oxide nanoparticles, and the fluorine compound contained in the resin composition of Example 5 were similar to those of Example 1.

In Example 5, the weighted average of functionality of the resin (A) was 4.77, and A/B was 4.70.

In Example 5, the glass transition temperature Tg was 76.8° C. The loss tangent tan δ at the glass transition temperature Tg was 0.1017.

In the folding test of Example 5, there was no change even after 200K folds of the hard coat film. In Example 5, the water contact angle before the abrasion test was 113.4°, and the water contact angle after the abrasion test was 106.5°. Visible scratches were not recognized.

TABLE 2

| Formulation | | Example 6 | Example 7 | Example 8 | Example 9 | Example 10 |
|---|---|---|---|---|---|---|
| monomer | SR833S | 9.4 | 5.64 | 4.7 | 3.76 | 2.82 |
| (A) | DPHA | 18.8 | 20.68 | 25.38 | 26.32 | 27.26 |
| oligomer | CN989 | 9.4 | 11.28 | 7.52 | 7.52 | 7.52 |
| (B) | CN929 | — | — | — | — | — |
| photoinitiator | Omnirad 184 | — | — | — | — | — |
| | Omnirad 500 | 5.64 | 5.64 | 5.64 | 5.64 | 5.64 |
| | Omnirad TPO | 1.41 | 1.41 | 1.41 | 1.41 | 1.41 |
| solvent | PGME | 46.984 | 46.984 | 46.984 | 46.984 | 46.984 |
| nanoparticle | AL2260 | 7.52 | 7.52 | 7.52 | 7.52 | 7.52 |
| fluorinated additive | KY-1203 | 0.846 | 0.846 | 0.846 | 0.846 | 0.846 |
| TOTAL | | 100.00 | 100.00 | 100.00 | 100.00 | 100.00 |
| A/B | | 3.56 | 2.80 | 4.70 | 4.70 | 4.70 |
| Weighted average of functionality | | 4.25 | 4.62 | 4.87 | 4.98 | 5.09 |
| Properties | tan Delta, peak | 0.1125 | 0.1152 | 0.0912 | 0.1003 | 0.1007 |
| | Tg | 73.4 | 50.6 | 58.3 | 91.7 | 85.3 |
| | # Folds Passing | 200K | 200K | 200K | 200K | 200K |
| | (3 mm | | | | | |
| | outbending) | | | | | |
| | Folding | 3 | 3 | 3 | 3 | 3 |
| | Performance | | | | | |
| | Rating * | | | | | |
| | WCA before | 113.4 | 113.2 | 114.5 | 115.8 | 116.1 |
| | Abrasion | | | | | |
| | WCA after | 107.3 | 102.3 | 105.6 | 107.1 | 109.6 |
| | abrasion | | | | | |
| | WCA Falling Rate | 5.4 | 9.6 | 7.8 | 7.5 | 5.6 |
| | [%] | | | | | |
| | Visible Scratches | no | no | no | no | no |

* Folding Performance Rating:
3 = Exellent (no change after 200K folds)
2 = Acceptable (no change after 100K folds)
1 = Poor (changes occur before 100K folds

### Example 6

As shown in Table 2, the resin composition of Example 6 contained 9.4% by mass of “SR833S” and 18.8% by mass of “DPHA” as resin (A), and 9.4% by mass of “CN989” as resin (B). The active energy ray polymerization initiator, the solvent, the metal oxide nanoparticles, and the fluorine compound contained in the resin composition of Example 6 were similar to those of Example 1.

In Example 6, the weighted average of functionality of the resin (A) was 4.25, and A/B was 3.56.

In Example 6, the glass transition temperature Tg was 73.4° C. The loss tangent tan δ at the glass transition temperature Tg was 0.1125.

In the folding test of Example 6, there was no change even after 200K folds of the hard coat film. In Example 6, the water contact angle before the abrasion test was 113.4°, and the water contact angle after the abrasion test was 107.3°. Visible scratches were not recognized.

### Example 7

As shown in Table 2, the resin composition of Example 7 contained 5.64% by mass of “SR833S” and 20.68% by mass of “DPHA” as resin (A), and 11.28% by mass of “CN989” as resin (B). The active energy ray polymerization initiator, the solvent, the metal oxide nanoparticles, and the fluorine compound contained in the resin composition of Example 7 were similar to those of Example 1.

In Example 7, the weighted average of functionality of the resin (A) was 4.62, and A/B was 2.80.

In Example 7, the glass transition temperature Tg was 50.6° C. The loss tangent tan δ at the glass transition temperature Tg was 0.1152.

In the folding test of Example 7, there was no change even after 200K folds of the hard coat film. In Example 7, the water contact angle before the abrasion test was 113.2°, and the water contact angle after the abrasion test was 102.3°. Visible scratches were not recognized.

### Example 8

As shown in Table 2, the resin composition of Example 8 contained 4.7% by mass of “SR833S” and 25.38% by mass of “DPHA” as resin (A), and 7.52% by mass of “CN989” as resin (B). The active energy ray polymerization initiator, the solvent, the metal oxide nanoparticles, and the fluorine compound contained in the resin composition of Example 8 were similar to those of Example 1.

In Example 8, the weighted average of functionality of the resin (A) was 4.87, and A/B was 4.70.

In Example 8, the glass transition temperature Tg was 58.3° C. The loss tangent tan δ at the glass transition temperature Tg was 0.0912.

In the folding test of Example 8, there was no change even after 200K folds of the hard coat film. In Example 8, the water contact angle before the abrasion test was 114.5°, and the water contact angle after the abrasion test was 105.6°. Visible scratches were not recognized.

### Example 9

As shown in Table 2, the resin composition of Example 9 contained 3.76% by mass of “SR833S” and 26.32% by mass of “DPHA” as resin (A), and 7.52% by mass of “CN989” as resin (B). The active energy ray polymerization initiator, the solvent, the metal oxide nanoparticles, and the fluorine compound contained in the resin composition of Example 9 were similar to those of Example 1.

In Example 9, the weighted average of functionality of the resin (A) was 4.98, and A/B was 4.70.

In Example 9, the glass transition temperature Tg was 91.7° C. The loss tangent tan δ at the glass transition temperature Tg was 0.1003.

In the folding test of Example 9, there was no change even after 200K folds of the hard coat film. In Example 9, the water contact angle before the abrasion test was 115.8°, and the water contact angle after the abrasion test was 107.1°. Visible scratches were not recognized.

### Example 10

As shown in Table 2, the resin composition of Example 10 contained 2.82% by mass of “SR833S” and 27.26% by mass of “DPHA” as resin (A), and 7.52% by mass of “CN989” as resin (B). The active energy ray polymerization initiator, the solvent, the metal oxide nanoparticles, and the fluorine compound contained in the resin composition of Example 10 were similar to those of Example 1.

In Example 10, the weighted average of functionality of the resin (A) was 5.09, and A/B was 4.70.

In Example 10, the glass transition temperature Tg was 85.3° C. The loss tangent tan δ at the glass transition temperature Tg was 0.1007.

In the folding test of Example 10, there was no change even after 200K folds of the hard coat film. In Example 10, the water contact angle before the abrasion test was 116.1°, and the water contact angle after the abrasion test was 109.6°. Visible scratches were not recognized.

TABLE3

| Formulation | | Example 11 | Example 12 | Example 13 |
|---|---|---|---|---|
| monomer | SR833S | 5.64 | 8.064 | 8.014 |
| (A) | DPHA | 27.26 | 24.192 | 22.04 |
| oligomer | CN989 | 4.7 | — | 10.02 |
| (B) | CN929 | — | 8.064 | — |
| photoinitiator | Omnirad 184 | — | 1.613 | 1.603 |
| | Omnirad 500 | 5.64 | — | — |
| | Omnirad TPO | 1.41 | — | — |
| solvent | PGME | 46.984 | 49.693 | 50 |
| nanoparticle | AL2260 | 7.52 | 8.064 | 8.014 |
| fluorinated additive | KY-1203 | 0.846 | 0.31 | 0.31 |
| TOTAL | | 100.00 | 100.00 | 100.00 |
| A/B | | 8.12 | 4.70 | 3.56 |
| Weighted average of functionality | | 4.86 | 4.55 | 4.47 |
| Properties | tan Delta, peak | 0.0912 | 0.09 | 0.099 |
| | Tg | 58.3 | 69.4 | 80 |
| | # Folds Passing | 200K | >250K | >250K |
| | (3 mm | | | |
| | outbending) | | | |
| | Folding | 3 | 3 | 3 |
| | Performance | | | |
| | Rating * | | | |
| | WCA before | 116.7 | 115.3 | 114.9 |
| | Abrasion | | | |
| | WCA after | 110.2 | 107.7 | 105.9 |
| | abrasion | | | |
| | WCA Falling Rate | 5.6 | 6.6 | 7.8 |
| | [%] | | | |
| | Visible Scratches | no | no | no |

* Folding Performance Rating:
3 = Exellent (no change after 200K folds)
2 = Acceptable (no change after 100K folds)
1 = Poor (changes occur before 100K folds

### Example 11

As shown in Table 3, the resin composition of Example 11 contained 5.64% by mass of “SR833S” and 27.26% by mass of “DPHA” as resin (A), and 4.7% by mass of “CN989” as resin (B). The active energy ray polymerization initiator, the solvent, the metal oxide nanoparticles, and the fluorine compound contained in the resin composition of Example 11 were similar to those of Example 1.

In Example 11, the weighted average of functionality of the resin (A) was 4.86, and A/B was 8.12.

In Example 11, the glass transition temperature Tg was 58.3° C. The loss tangent tan δ at the glass transition temperature Tg was 0.0912.

In the folding test of Example 11, there was no change even after 200K folds of the hard coat film. In Example 11, the water contact angle before the abrasion test was 116.7°, and the water contact angle after the abrasion test was 110.2°. Visible scratches were not recognized.

### Example 12

As shown in Table 3, the resin composition of Example 12 contained 8.064% by mass of “SR833S” and 24.192% by mass of “DPHA” as resin (A), 8.064% by mass of “CN929” available from SARTOMER as resin (B), 1.613% by mass of “OMNIRAD 184” available from IGM RESINS as the active energy ray polymerization initiator, 49.693% by mass of “PGME” as the solvent, 8.064% by mass of “AL2260” as the metal oxide nanoparticles, and 0.31% by mass of “KY-1203” as the fluorine compound.

In Example 12, the weighted average of functionality of the resin (A) was 4.55, and A/B was 4.70.

In Example 12, the glass transition temperature Tg was 69.4° C. The loss tangent tan δ at the glass transition temperature Tg was 0.09.

In the folding test of Example 12, there was no change even after two hundred and five thousand (250K) folds or more of the hard coat film. In Example 12, the water contact angle before the abrasion test was 115.3°, and the water contact angle after the abrasion test was 107.7°. Visible scratches were not recognized.

### Example 13

As shown in Table 3, the resin composition of Example 13 contained 8.014% by mass of “SR833S” and 22.04% by mass of “DPHA” as resin (A), 10.02% by mass of “CN989” as resin (B), 1.603% by mass of “OMNIRAD 184” as the active energy ray polymerization initiator, 50% by mass of “PGME” as the solvent, 8.014% by mass of “AL2260” as the metal oxide nanoparticles, and 0.31% by mass of “KY-1203” as the fluorine compound.

In Example 13, the weighted average of functionality of the resin (A) was 4.47, and A/B was 3.56.

In Example 13, the glass transition temperature Tg was 80° C. The loss tangent tan δ at the glass transition temperature Tg was 0.099.

In the folding test of Example 13, there was no change even after 250K folds or more of the hard coat film. In Example 13, the water contact angle before the abrasion test was 114.9°, and the water contact angle after the abrasion test was 105.9°. Visible scratches were not recognized.

As described above, in Examples 1 to 13, the weighted average of functionality of resin (A) was more than or equal to 4. Therefore, the glass transition temperature Tg of Examples 1 to 13 fell within a range of more than or equal to 50° C. and less than or equal to 100° C., and the loss tangent tan δ at the glass transition temperature Tg fell within a range of more than or equal to 0.07 and less than or equal to 0.15. Thus, it is presumed that the number of folds of Examples 1 to 13 was more than or equal to 200K. It is also presumed that the water contact angle before the abrasion test in Examples 1 to 13 was more than 110° and the water contact angle after the abrasion test was more than 100°. It is also presumed that in Examples 1 to 13, the decrease in the water contact angle after the abrasion test with respect to the water contact angle before the abrasion test was less than 13%. It is also seen that visible scratches were not recognized in Examples 1 to 13. In other words, it was confirmed that Examples 1 to 13 had performance capable of withstanding multiple and repeated folds, and enabled improved scratch resistance and abrasion resistance even in an in-vehicle or similar high-temperature environment.

TABLE 4

| | | Comparative | Comparative | Comparative | Comparative | Comparative |
|---|---|---|---|---|---|---|
| Formulation | | Example 1 | Example 2 | Example 3 | Example 4 | Example 5 |
| monomer | SR833S | 7.515 | — | — | — | — |
| (A) | SR306 (TPGDA) | 5.01 | — | — | — | — |
| | DPHA | 9.018 | — | — | — | — |
| | SR444 | — | 16.65 | 7.35 | 7.35 | 7.35 |
| | IBOA (SR506-A) | — | — | 24.51 | 22.06 | 19.61 |
| oligomer | CN989 | — | — | — | — | — |
| (B) | CN929 | 16.032 | — | — | — | — |
| | CN9047 | — | — | 9.81 | 12.26 | 14.71 |
| | PU610 | — | 30.91 | — | — | — |
| photoinitiator | Omnirad 184 | 2.004 | 2.37 | 0.98 | 0.98 | 0.98 |
| | Omnirad 500 | — | — | — | — | — |
| | Omnirad TPO | — | — | — | — | — |
| solvent | PGME | 50.09 | 49.76 | 49.75 | 49.75 | 49.75 |
| nanoparticle | AL2460 | 10.02 | — | — | — | — |
| | AL2260 | — | — | 7.35 | 7.35 | 7.35 |
| fluorinated additive | KY-1203 | 0.31 | 0.31 | 0.25 | 0.25 | 0.25 |
| TOTAL | | 100.00 | 100.00 | 100.00 | 100.00 | 100.00 |
| A/B | | 1.78 | 0.54 | 3.77 | 2.82 | 2.18 |
| Weighted average of functionality | | 2.77 | 3.00 | 1.54 | 1.57 | 1.62 |
| Properties | tan Delta, peak | 0.1516 | 0.055 | 0.25 | 0.208 | 0.194 |
| | Tg | 59.5 | 100° | 129.6 | 117.8 | 106.3 |
| | # Folds Passing | >250K | <100 | 200K | 200K | 200K |
| | (3 mm | | | | | |
| | outbending) | | | | | |
| | Folding | 3 | 1 | 3 | 3 | 3 |
| | Performance | | | | | |
| | Rating * | | | | | |
| | WCA before | 115 | 110 | 113.4 | 113.7 | 114.1 |
| | Abrasion | | | | | |
| | WCA after | 106 | 95 | 87.3 | 73.9 | 76.1 |
| | abrasion | | | | | |
| | WCA Falling Rate | 7.8 | 13.6 | 23 | 35 | 33.3 |
| | [%] | | | | | |
| | Visible Scratches | yes | no | yes | yes | yes |

* Folding Performance Rating:
3 = Exellent (no change after 200K folds)
2 = Acceptable (no change after 100K folds)
1 = Poor (changes occur before 100K folds

### Comparative Example 1

As shown in Table 4, the resin composition of Comparative Example 1 contained 7.515% by mass of “SR833S”, 5.01% by mass of “SR306 (TPGDA)” available from SARTOMER, and 9.018% by mass of “DPHA” as resin (A), 16.032% by mass of “CN929” as resin (B), 2.004% by mass of “OMNIRAD 184” as the active energy ray polymerization initiator, 50.09% by mass of “PGME” as the solvent, 10.02% by mass of “AL2460” available from NANOPHASE TECHNOLOGIES CORPORATION as the metal oxide nanoparticles, and 0.31% by mass of “KY-1203” as the fluorine compound.

In Comparative Example 1, the weighted average of functionality of the resin (A) was 2.77, and A/B was 1.78.

In Comparative Example 1, the glass transition temperature Tg was 59.5° C. The loss tangent tan δ at the glass transition temperature Tg was 0.1516.

In the folding test of Comparative Example 1, there was no change even after 250K folds or more of the film. The water contact angle before the abrasion test was 115°, and the water contact angle after the abrasion test was 106°. On the other hand, visible scratches were recognized.

As described above, in Comparative Example 1, the weighted average of functionality of the resin (A) contained in the resin composition was 2.77.

Therefore, the loss tangent tan δ at the glass transition temperature Tg of Comparative Example 1 was as high as 0.1516, which means that the film was slightly reduced in flexibility. Thus, this is presumed to be the reason why visible scratches were recognized in Comparative Example 1.

### Comparative Example 2

As shown in Table 4, the resin composition of Comparative Example 2 contained 16.65% by mass of “SR444” available from SARTOMER as resin (A), 30.91% by mass of “PU610” available from MIWON SPECIALTY CHEMICAL as resin (B), 2.37% by mass of “OMNIRAD 184” as the active energy ray polymerization initiator, 49.76% by mass of “PGME” as the solvent, and 0.31% by mass of “KY-1203” as the fluorine compound. Note that the resin composition of Comparative Example 2 did not contain metal oxide nanoparticles. In addition, “SR444” is a monomer composed mainly of trifunctional groups and containing four functional groups.

In Comparative Example 2, the weighted average of functionality of the resin (A) was 3.00, and A/B was 0.54.

In Comparative Example 2, the glass transition temperature Tg was 100° C. The loss tangent tan δ at the glass transition temperature Tg was 0.055.

In the folding test of Comparative Example 2, the sample was cracked in the course of folding the film 100 times. In Comparative Example 2, the water contact angle before the abrasion test was 110°, and the water contact angle after the abrasion test was 95°. Visible scratches were not recognized.

As described above, in Comparative Example 2, the weighted average of functionality of the resin (A) contained in the resin composition was 3.00. Therefore, the loss tangent tan δ at the glass transition temperature Tg of Comparative Example 2 was as low as 0.055, and the film had excessively high hardness. This is presumed to be the reason why the number of folds of Comparative Example 2 was less than or equal to 100. On the whole, it is considered that in Comparative Example 2, scratches were not recognized because the crosslinking density was increased which increased the scratch resistance, whereas the flexibility was lost due to the excessive increase in crosslinking density, and a favorable result was not obtained in the folding test.

### Comparative Example 3

As shown in Table 4, the resin composition of Comparative Example 3 contained 7.35% by mass of “SR444” and 24.51% by mass of “IBOA (SR506-A)” available from SARTOMER as resin (A), 9.81% by mass of “CN9047” available from SARTOMER as resin (B), 0.98% by mass of “OMNIRAD 184” as the active energy ray polymerization initiator, 49.75% by mass of “PGME” as the solvent, 7.35% by mass of “AL2260” as the metal oxide nanoparticles, and 0.25% by mass of “KY-1203” as the fluorine compound. Herein, “IBOA (SR506-A)” is a monofunctional monomer.

In Comparative Example 3, the weighted average of functionality of the resin (A) was 1.54, and A/B was 3.77.

In Comparative Example 3, the glass transition temperature Tg was 129.6° C. The loss tangent tan δ at the glass transition temperature Tg was 0.25.

In the folding test of Comparative Example 3, there was no change even after 200K folds of the film. However, in Comparative Example 3, the water contact angle before the abrasion test was 113.4°, and the water contact angle after the abrasion test was 87.3°. Visible scratches were recognized.

As described above, in Comparative Example 3, the weighted average of functionality of the resin (A) contained in the resin composition was 1.54. Therefore, the glass transition temperature Tg of Comparative Example 3 was as high as 129.6° C. The loss tangent tan δ at the glass transition temperature Tg of Comparative Example 3 was as high as 0.25. In other words, it is presumed that a favorable result was exhibited in the folding test since Comparative Example 3 had a low crosslinking density because of a high tan δ, and was flexible, however, visible scratches were recognized after the abrasion test due to excessively low hardness.

### Comparative Example 4

As shown in Table 4, the resin composition of Comparative Example 4 contained 7.35% by mass of “SR444” and 22.06% by mass of “IBOA (SR506-A)” as resin (A), and 12.26% by mass of “CN9047” as resin (B). The active energy ray polymerization initiator, the solvent, the metal oxide nanoparticles, and the fluorine compound contained in the resin composition of Comparative Example 4 were similar to those of Comparative Example 3.

In Comparative Example 4, the weighted average of functionality of the resin (A) was 1.57, and A/B was 2.82.

In Comparative Example 4, the glass transition temperature Tg was 117.8° C. The loss tangent tan δ at the glass transition temperature Tg was 0.208.

In the folding test of Comparative Example 4, there was no change even after 200K folds of the film. However, in Comparative Example 4, the water contact angle before the abrasion test was 113.7°, and the water contact angle after the abrasion test was 73.9°. Visible scratches were recognized.

As described above, in Comparative Example 4, the weighted average of functionality of the resin (A) contained in the resin composition was 1.57. Therefore, the glass transition temperature Tg of Comparative Example 4 was as high as 117.8° C. The loss tangent tan δ at the glass transition temperature Tg of Comparative Example 4 was as high as 0.208. In other words, it is presumed that a favorable result was exhibited in the folding test because Comparative Example 4 had a low crosslinking density because of a high tan δ, and was flexible, however, visible scratches were recognized after the abrasion test due to excessively low hardness.

### Comparative Example 5

As shown in Table 4, the resin composition of Comparative Example 5 contained 7.35% by mass of “SR444” and 19.61% by mass of “IBOA (SR506-A)” as resin (A), and 14.71% by mass of “CN9047” as resin (B). The active energy ray polymerization initiator, the solvent, the metal oxide nanoparticles, and the fluorine compound contained in the resin composition of Comparative Example 5 were similar to those of Comparative Example 3.

In Comparative Example 5, the weighted average of functionality of the resin (A) was 1.62, and A/B was 2.18.

In Comparative Example 5, the glass transition temperature Tg was 106.3° C. The loss tangent tan δ at the glass transition temperature Tg was 0.194.

In the folding test of Comparative Example 5, there was no change even after 200K folds of the film. However, in Comparative Example 5, the water contact angle before the abrasion test was 114.1°, and the water contact angle after the abrasion test was 76.1°. Visible scratches were recognized.

As described above, in Comparative Example 5, the weighted average of functionality of the resin (A) contained in the resin composition was 1.62. Therefore, the glass transition temperature Tg of Comparative Example 5 was as high as 106.3° C. The loss tangent tan δ at the glass transition temperature Tg of Comparative Example 5 was as high as 0.194. In other words, it is presumed that a favorable result was exhibited in the folding test since Comparative Example 5 had a low crosslinking density because of a high tan δ, and was flexible, however, visible scratches were recognized after the abrasion test due to excessively low hardness.

TABLE5

| | | Comparative | Comparative | Comparative |
|---|---|---|---|---|
| Formulation | | Example 6 | Example 7 | Example 8 |
| monomer | SR833S | — | — | — |
| (A) | SR306 (TPGDA) | — | — | — |
| | DPHA | — | — | — |
| | SR444 | 4.9 | 4.9 | 4.9 |
| | IBOA (SR506-A) | 24.51 | 22.06 | 19.61 |
| oligomer | CN989 | — | — | — |
| (B) | CN929 | — | — | — |
| | CN9047 | 12.26 | 14.71 | 17.16 |
| | PU610 | — | — | — |
| photoinitiator | Omnirad 184 | 0.98 | 0.98 | 0.98 |
| | Omnirad 500 | — | — | — |
| | Omnirad TPO | — | — | — |
| solvent | PGME | 49.75 | 49.75 | 49.75 |
| nanoparticle | AL2460 | — | — | — |
| | AL2260 | 7.35 | 7.35 | 7.35 |
| fluorinated additive | KY-1203 | 0.25 | 0.25 | 0.25 |
| TOTAL | | 100.00 | 100.00 | 100.00 |
| A/B | | 2.82 | 2.18 | 1.73 |
| Weighted average of functionality | | 1.43 | 1.47 | 1.50 |
| Properties | tan Delta, peak | 0.2791 | 0.2455 | 0.2183 |
| | Tg | 111.9 | 102.7 | 93.2 |
| | # Folds Passing | 200K | 200K | 200K |
| | (3 mm | | | |
| | outbending) | | | |
| | Folding | 3 | 3 | 3 |
| | Performance | | | |
| | Rating * | | | |
| | WCA before | 113.5 | 113.5 | 107 |
| | Abrasion | | | |
| | WCA after | 77.4 | 70.3 | 65 |
| | abrasion | | | |
| | WCA Falling Rate | 31.8 | 38.1 | 39.2 |
| | [%] | | | |
| | Visible Scratches | yes | yes | yes |

* Folding Performance Rating:
3 = Exellent (no change after 200K folds)
2 = Acceptable (no change after 100K folds)
1 = Poor (changes occur before 100K folds

### Comparative Example 6

As shown in Table 5, the resin composition of Comparative Example 6 contained 4.9% by mass of “SR444” and 24.51% by mass of “IBOA (SR506-A)” as resin (A), and 12.26% by mass of “CN9047” as resin (B). The active energy ray polymerization initiator, the solvent, the metal oxide nanoparticles, and the fluorine compound contained in the resin composition of Comparative Example 6 were similar to those of Comparative Example 3.

In Comparative Example 6, the weighted average of functionality of the resin (A) was 1.43, and A/B was 2.82.

In Comparative Example 6, the glass transition temperature Tg was 111.9° C. The loss tangent tan δ at the glass transition temperature Tg was 0.2791.

In the folding test of Comparative Example 6, there was no change even after 200K folds of the film. However, in Comparative Example 6, the water contact angle before the abrasion test was 113.5°, and the water contact angle after the abrasion test was 77.4°. Visible scratches were recognized.

As described above, in Comparative Example 6, the weighted average of functionality of the resin (A) contained in the resin composition was 1.43. Therefore, the glass transition temperature Tg of Comparative Example 6 was as high as 111.9° C. The loss tangent tan δ at the glass transition temperature Tg of Comparative Example 6 was as high as 0.2791. In other words, it is presumed that a favorable result was exhibited in the folding test because Comparative Example 6 had a low crosslinking density because of a high tan δ, and was flexible, however, visible scratches were recognized after the abrasion test due to excessively low hardness.

### Comparative Example 7

As shown in Table 5, the resin composition of Comparative Example 7 contained 4.9% by mass of “SR444” and 22.06% by mass of “IBOA (SR506-A)” as resin (A), and 14.71% by mass of “CN9047” as resin (B). The active energy ray polymerization initiator, the solvent, the metal oxide nanoparticles, and the fluorine compound contained in the resin composition of Comparative Example 7 were similar to those of Comparative Example 3.

In Comparative Example 7, the weighted average of functionality of the resin (A) was 1.47, and A/B was 2.18.

In Comparative Example 7, the glass transition temperature Tg was 102.7° C. The loss tangent tan δ at the glass transition temperature Tg was 0.2455.

In the folding test of Comparative Example 7, there was no change even after 200K folds of the film. However, in Comparative Example 7, the water contact angle before the abrasion test was 113.5°, and the water contact angle after the abrasion test was 70.3°. Visible scratches were recognized.

As described above, in Comparative Example 7, the weighted average of functionality of the resin (A) contained in the resin composition was 1.47. Therefore, the glass transition temperature Tg of Comparative Example 7 was as high as 102.7° C. The loss tangent tan δ at the glass transition temperature Tg of Comparative Example 7 was as high as 0.2455. In other words, it is presumed that a favorable result was exhibited in the folding test because Comparative Example 7 had a low crosslinking density because of a high tan δ, and was flexible, however, visible scratches were recognized after the abrasion test due to excessively low hardness.

### Comparative Example 8

As shown in Table 5, the resin composition of Comparative Example 8 contained 4.9% by mass of “SR444” and 19.61% by mass of “IBOA (SR506-A)” as resin (A), and 17.16% by mass of “CN9047” as resin (B). The active energy ray polymerization initiator, the solvent, the metal oxide nanoparticles, and the fluorine compound contained in the resin composition of Comparative Example 8 were similar to those of Comparative Example 3.

In Comparative Example 8, the weighted average of functionality of the resin (A) was 1.50, and A/B was 1.73.

In Comparative Example 8, the glass transition temperature Tg was 93.2° C. The loss tangent tan δ at the glass transition temperature Tg was 0.2183.

In the folding test of Comparative Example 8, there was no change even after 200K folds of the film. However, in Comparative Example 8, the water contact angle before the abrasion test was 107°, and the water contact angle after the abrasion test was 65°. Visible scratches were recognized.

As described above, in Comparative Example 8, the weighted average of functionality of the resin (A) contained in the resin composition was 1.50. Therefore, the loss tangent tan δ at the glass transition temperature Tg of Comparative Example 8 was as high as 0.2183, and hardness was excessively low. This is presumed why the water contact angle after the abrasion test of Comparative Example 8 was as low as 65°, and visible scratches were recognized.

As described above, according to the present embodiment, the hard coat film 10 having both performance capable of withstanding multiple and repeated folds and the scratch and abrasion resistances can be provided.

Embodiments of the present invention have been described above with reference to the accompanying drawings. However, the invention disclosed herein is not limited thereto, and a person having ordinary skill in the art would appreciate various alterations and modifications within the scope of the present disclosure and the claims.

The hard coat film 10 of the present invention can be employed as a protective film in every device in which such a film is desired, such as in a display screen of a display device, a screen, a goggle, an eye shield, and a face shield. The hard coat film 10 disclosed above is particularly suitable for a (foldable) flexible display to be used in a bent manner, electronic equipment such as an information terminal, and every other similar good.

When the hard coat film 10 of the present disclosure is employed for a display device, the hard coat film 10 may include a functional material layer for improving visibility and/or an adhesive layer. Examples of the functional material layer can include a diffusive layer, an antireflection layer, and the like. Examples of the adhesive layer can include a photoelastic resin layer and the like.

### REFERENCE SIGNS LIST

10 hard coat film
11 base material
12 hard coating layer
12a first region
12b second region
13 antifouling layer
100 manufacturing apparatus
110 delivery roll
112 wind-up roll
114a-d guide rolls
120 coating device
130 drying device
140 curing device
144 guide roll
146 guide roll
148 light source

1. A hard coat film comprising:
a base material; and
a hard coating layer comprising a cured product of a resin composition containing a resin (A) and a resin (B), the hard coating layer being laminated on the base material, wherein
the resin (A) is a polyfunctional (meth)acrylic monomer having a weighted average of functionality of more than or equal to 4,
the resin (B) is an aliphatic urethane acrylate,
a glass transition temperature Tg of the hard coating layer is more than or equal to 50° C. and less than or equal to 100° C., and
a loss tangent tan δ at the glass transition temperature Tg is more than or equal to 0.07 and less than or equal to 0.15,
wherein the loss tangent tan δ of the hard coating layer is measured by dynamic viscoelastic measurement applying a 1-Hz frequency dynamic load.

2. The hard coat film according to claim 1, wherein the resin composition further comprises metal oxide nanoparticles having an average particle size of less than or equal to 100 nm.

3. The hard coat film according to claim 2, wherein a content of the metal oxide nanoparticles contained in the resin composition is more than or equal to 2% by mass and less than or equal to 5% by mass of a total solid content of the resin composition of the hard coating layer.

4. The hard coat film according to claim 2, wherein a metal oxide constituting the metal oxide nanoparticles is either or both of silica and alumina.

5. The hard coat film according to claim 2, wherein the metal oxide nanoparticles have a Mohs hardness of more than 6.

6. The hard coat film according to claim 1, a water contact angle of the surface of the hard coating layer after abrasion is more than 100°,
wherein abrasion is performed using an abrasion tester through use of steel wool #0000, abrading a surface of the hard coating layer with the steel wool under conditions of a load of 1000 g, a speed of 50 mm/sec, a reciprocating distance of 40 mm, and 2500 reciprocations.

7. The hard coat film according to claim 6, wherein a water contact angle of the surface of the hard coating layer before abrasion is more than 110°.

8. The hard coat film according to claim 7, wherein a decrease in the water contact angle after abrasion with respect to the water contact angle of the surface of the hard coating layer before abrasion is less than 13%.

9. The hard coat film according to claim 7, wherein a content of the resin (A) contained in the resin composition is more than two times and less than nine times a content of the resin (B).

10. The hard coat film according to claim 9, wherein a content of the resin (A) contained in the resin composition is more than or equal to 20% by mass and less than or equal to 40% by mass, and a content of the resin (B) contained in the resin composition is more than or equal to 2% by mass and less than or equal to 15% by mass.

11. The hard coat film according to claim 1, wherein the hard coat film is configured to be foldable by either inbending or outbending at least one hundred thousand times without causing any cracking, interlayer separation, or loss of an optical property.

12. The hard coat film according to claim 1, wherein the base material is a thermoplastic base material having a thickness of more than or equal to 10 μm and less than or equal to 200 μm.

13. The hard coat film according to claim 1, wherein the resin composition contains a fluorine compound, and the fluorine compound is segregated to a first region located on a side of a surface of the hard coating layer.

14. The hard coat film according to claim 13, wherein the fluorine compound as segregated provides an antifouling effect.

15. The hard coat film according to claim 13, wherein the fluorine compound is segregated to a surface of the hard coating layer.

16. The hard coat film according to claim 11, wherein the hard coat film is configured to be foldable by either inbending or outbending at least one hundred thousand times without any loss of an optical property, wherein the optical property is one or more selected from the group consisting of variations in total transmittance (%), transmission haze, gloss, and chromaticity b*(intensity of color tone from blue to yellow).

17. The hard coat film according to claim 13, wherein in a second region located on a side of the base material of the hard coating layer, the fluorine compound is not segregated.
